(19) United States
(12) Patent Application Publication
(10) Pub. No.: US 2020/0079411 A1
(43) Pub. Date: Mar. 12, 2020

(54) Transportable Test System

(71) Applicant: ALSTOM Transport Technologies, SAINT-OUEN (FR)

(72) Inventor: Laurent COLLONGUES, ORLEIX (FR)

(21) Appl. No.: 16/563,721

(22) Filed: Sep. 6, 2019

(30) Foreign Application Priority Data
Sep. 6, 2018 (FR) 18 58003

(51) Int. Cl. B62B 5/04

(52) U.S. Cl. CPC B62B 5/049; B62B 2202/67

(57) ABSTRACT

A test system includes a transport container, a fixed chassis located inside the transport container, and a test device arranged inside the transport container. The test device includes at least one trolley mounted movably on the chassis among a plurality of positions located in the container. The trolley is configured to receive a piece of test equipment configured to test a piece of equipment to be tested. The test device includes a fastener configured to fasten the trolley removably on the chassis.

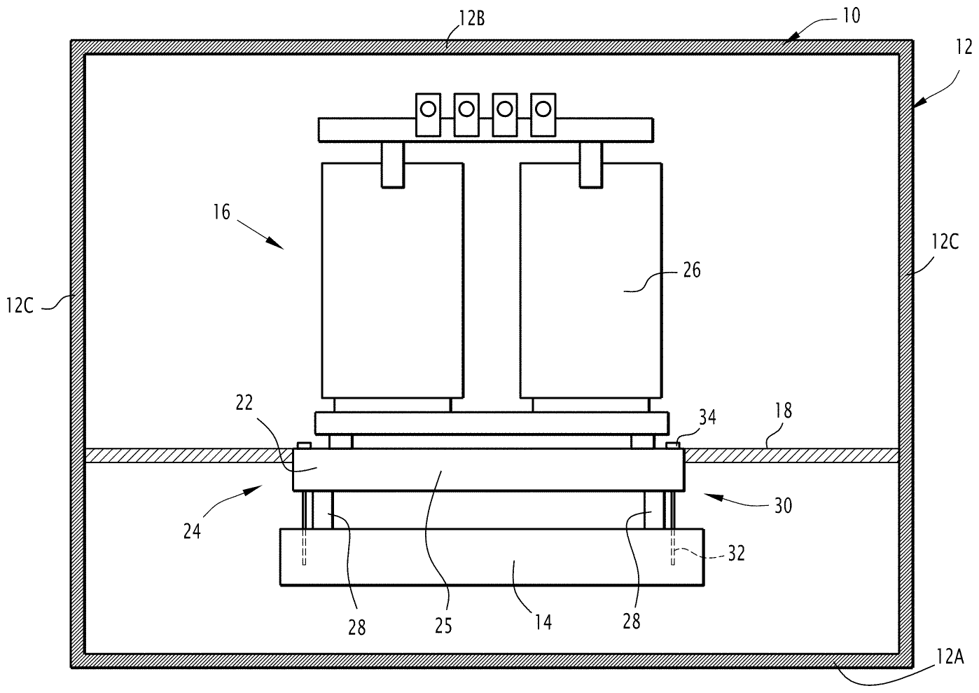

### TECHNICAL FIELD OF THE INVENTION

The present invention relates to a transportable test system, of the type comprising a transport container, a fixed chassis located inside the transport container, and a test device arranged inside the transport container, the test device being configured to receive a piece of test equipment configured to test a piece of equipment to be tested.

### BACKGROUND OF THE INVENTION

Such a test system is easily transportable and can for example be used for a rapid deployment in desired locations, for example on worksites. The test equipment can be inserted inside the transport container in order to test various products, without having to establish a test laboratory beforehand in these locations.

However, such a test system is not fully satisfactory. Indeed, the test equipment to be arranged inside the transport container may be damaged, for example in case of movement of the container.

### SUMMARY OF THE INVENTION

One of the aims of the invention is to offset these drawbacks.

To that end, the invention relates to a test system comprising a transport container, a fixed chassis located inside the transport container, and a test device arranged inside the transport container, the test device including at least one trolley mounted movably on the chassis among a plurality of positions located in the container, the trolley being configured to receive a piece of test equipment configured to test a piece of equipment to be tested, the test device including a fastening device configured to fasten the trolley removably on the chassis.

In specific embodiments of the invention, the test system further has one or more of the following features, considered individually or according to any technically possible combination(s):
the system further comprises a floor mounted removably in the transport container;
the floor is configured to prevent the manipulation of the fastening device to fasten the trolley and/or to release the trolley when the floor is mounted in the container;
the fastening device comprises at least one fastening assembly, each fastening assembly comprising a fastening element in the form of a threaded rod;
each fastening assembly comprises at least one nut configured to be screwed on the fastening element;
the fastening device comprises several fastening assemblies, for example four fastening assemblies;
the trolley comprises several wheels configured so that the trolley rolls on the chassis by means of these wheels;
at least one wheel is a guide wheel, each of the wheels advantageously being guide wheels;
the container is a road, rail and/or sea transport container; and
the test device is configured to conduct tests on a piece of equipment to be tested arranged outside the transport container.

### BRIEF DESCRIPTION OF THE DRAWINGS

Other features and advantages of the invention will appear upon reading the following description, provided solely as a non-limiting example, and done in reference to the sole FIGURE, which is a sectional view of a test system according to one embodiment of the invention.

### DETAILED DESCRIPTION OF SOME EMBODIMENTS

In reference to the FIGURE, the test system 10 comprises a transport container 12, a fixed chassis 14 located inside the transport container 12, a test device 16 arranged inside the transport container 12, and a floor 18 mounted removably inside the transport container 12.

The transport container 12 is a road, rail and/or sea transport container.

The transport container 12 is parallelepiped in shape. It extends in a longitudinal direction. The longitudinal direction here is perpendicular to the plane of the FIGURE.

In a known manner, the transport container 12 is for example provided with doors at least at one of its longitudinal ends, preferably at each of its longitudinal ends.

The transport container 12 delimits an inner volume.

The transport container 12 has a lower wall 12A, an upper wall 12B, and side walls 12C defining the inner volume.

The fixed chassis 14, the test device 16, and the floor 18 are arranged in a test compartment of the transport container 12.

The transport container 12 for example comprises a single test compartment. In a variant, it comprises several tests compartments separated by inner partitions.

The chassis 14 is substantially rectilinear. It for example has a rail shape extending in the longitudinal direction of the transport container 12.

The chassis 14 is fastened to the container 12, for example to the lower wall 12A of the container 12. The chassis 14 is for example fastened by welding.

The test device 16 includes at least one trolley 22 mounted movably on the chassis 12, and a fastening device 24 configured to fasten the trolley 22 removably on the chassis 12.

The trolley 22 has a frame 25 for example having a parallelepiped shape.

The trolley 22 is movable relative to the chassis 14 in a plurality of positions located in the container 12. It is intended to receive a piece of test equipment 26 configured to test a piece of equipment to be tested (not shown in the sole FIGURE).

The trolley 22 for example comprises several wheels 28. The wheels 28 are configured so that the trolley 22 rolls on the chassis 14 by means of these wheels 28. The wheels 28 here are mounted below the frame 25.

Preferably, at least one wheel 28 is a guide wheel. Preferably, at least two wheels are guide wheels. Advantageously, each of the wheels 28 is a guide wheel. Each guide wheel 28 is for example mounted pivoting on the frame 25 around a substantially vertical steering axis. More specifically, each wheel 28 is mounted rotating around a horizontal rotation axis on a wheel support, the wheel support being mounted pivoting on the frame 25 around the substantially vertical steering axis.

The friction between the wheel 28 and the chassis 14 is low, such that a single person can move the assembly formed by the trolley 22 and the piece of equipment 26 relative to the chassis 14.

The fastening device 24 is configured to immobilize the trolley 22 relative to the chassis 14, i.e., to fix the relative position of the trolley 22 with respect to the chassis 14.

The fastening device 24 comprises at least one fastening assembly 30, each fastening assembly 30 being configured to contribute to immobilizing the trolley 22 relative to the chassis 14. According to the embodiment shown in the sole FIGURE, the fastening device 24 comprises four fastening assemblies 30, each arranged at one of the four corners of the frame 25 of the trolley 22.

Each fastening assembly 30 here comprises a fastening element 32 in the form of a threaded rod, and at least one nut 34 configured to be screwed on the fastening element 32 so as to cooperate with the fastening element 32 in order to fasten the trolley 22 on the chassis 14.

The chassis 14 is for example provided with at least one tapped hole configured for the screwing of each fastening element 32 in the form of a threaded rod.

The trolley 22 is configured to receive the equipment 26 placed on the trolley 22. The piece of equipment 26 is arranged above the trolley 22.

The piece of equipment 26 is advantageously configured to be secured to the trolley 22 removably, for example by screwing.

The piece of equipment 26 is for example a piece of electrical equipment, in particular an electric transformer, charges, or inductances. It is configured to test a piece of equipment to be tested, for example a traction box arranged outside the transport container 12.

The floor 18 is mounted removably inside the transport container 12. It is movable between a deployed position, in which the floor 18 is mounted in the transport container 12 along the chassis 14 and covers at least part of the chassis 14, and a removed position in which the floor 18 is disassembled away from the chassis 14.

In the deployed position, the floor 18 allows an operator to move in the transport container 12, for example to operate test device 16. The floor 18 forms an interior layout of the transport container 12.

In one embodiment, in the deployed position, the floor 18 prevents access to the fastening device 24 in order to fasten the trolley 22 and/or to release the trolley 22. In the removed position of the floor 18, the fastening device 24 is manipulable and accessible. Thus, the trolley 22 is able to be fastened and/or released relative to the chassis 14.

Thus, when the floor 18 is fastened, it prevents separation of the trolley 22 from the chassis 14, and when it is removed, it is then possible to separate or secure the trolley 22 with respect to the chassis 14 by manipulating the fastening device 24, in particular each fastening assembly 30.

Owing to the invention described above, the trolley 22 and the piece of equipment 26 are able to be fastened to the chassis 14. This is particularly advantageous when the piece of equipment 26 is transferred with the container 12 and the chassis 14 to a desired location. Indeed, the possibility of collision between the trolley 22 and the piece of equipment 26 on the one hand and the transport container 12 on the other hand is substantially reduced.

Furthermore, the fastening of the trolley 22 on the chassis 14 can only be modified when the floor 18 is disassembled, which improves the safety of the fastening of the trolley 22 with the piece of equipment 26 on the chassis 12.

Lastly, this allows a quick replacement of the piece of equipment 26 in case of failure in order to obtain an optimized maintenance.

What is claimed is:

1. A test system comprising a transport container, a fixed chassis located inside the transport container, and a test device placed inside the transport container, the test device comprising at least one trolley mounted movably on the chassis among a plurality of positions located in the container, the trolley being configured to receive a piece of test equipment configured to test a piece of equipment to be tested, the test device comprising a fastener configured to fasten the trolley removably on the chassis.

2. The test system according to claim 1, further comprising a floor mounted removably in the transport container.

3. The test system according to claim 1, wherein the floor is configured to prevent the manipulation of the fastening device to fasten the trolley and/or to release the trolley when the floor is mounted in the container.

4. The test system according to claim 1, wherein the fastening device comprises at least one fastening assembly, each fastening assembly comprising a fastening element in the form of a threaded rod.

5. The test system according to claim 4, wherein each fastening assembly (30) comprises at least one nut configured to be screwed on the fastening element.

6. The test system according to claim 4, wherein the fastening device comprises several fastening assemblies.

7. The test system according to claim 1, wherein the trolley comprises several wheels configured so that the trolley rolls on the chassis by means of these wheels.

8. The test system according to claim 7, wherein at least one wheel is a guide wheel.

9. The test system according to claim 1, wherein the container is a road, rail and/or sea transport container.

10. The test system according to claim 1, wherein the test device is configured to conduct tests on a piece of equipment to be tested placed outside the transport container.

11. The test system according to claim 4, wherein the fastening device comprises four fastening assemblies.

12. The test system according to claim 7, wherein each of the wheels is a guide wheel.
